(19) United States
(12) Patent Application Publication
(10) Pub. No.: US 2007/0298792 A1
(43) Pub. Date: Dec. 27, 2007

(54) Mobile radio terminal device

(75) Inventors: Yoshiaki Otaki, Hamura-shi (JP); Chitose Sakaguchi, Kawasaki-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA

(21) Appl. No.: 11/516,306

(22) Filed: Sep. 5, 2006

(30) Foreign Application Priority Data
Jun. 27, 2006 (JP) 2006-176536

(51) Int. Cl. H04Q 7/20

(52) U.S. Cl. 455/435.1

(57) ABSTRACT

A control means extracts address book data including telephone numbers associated with preset subjects to display the names in the address book in a list onto a display unit, receives designation of an outgoing call destination from the list by a user through an operation unit, and makes an outgoing call by using a telephone number corresponding to the set subject out of the telephone numbers corresponding to the designated name of the outgoing call destination.

### CROSS-REFERENCE TO RELATED APPLICATIONS

This application is based upon and claims the benefit of priority from prior Japanese Patent Application No. 2006-176536, filed Jun. 27, 2006, the entire contents of which are incorporated herein by reference.

### BACKGROUND OF THE INVENTION

1. Field of the Invention

The present invention relates to a mobile radio terminal device equipped with a radio communication function, such as a cellular phone set and a personal handy phone system (PHS) terminal.

2. Description of the Related Art

As is well known, a mobile radio terminal device such as a conventional cellular phone set has been widely used irrespective of age or sex. A business person frequently uses the mobile terminal device both for private use and business use because of its convenience. Like this, the operation for both of the private use and business use has involved the problem that the convenience in using, for instance, address data, etc. to be registered becomes lower since such address data for the private use and the business use are brought mixed.

To overcome such a problem, the conventional mobile radio terminal device adds attributes for each data to perform color-coded displays in retrieving the data (see, for example, Jpn. Pat. Appln. KOKAI Publication No. 2001-313711). However, it is needed for a conventional method to designate its attribute every time the data is used, the convenience is not sufficiently high, and the problem is therefore not solved yet.

In the conventional mobile radio terminal device, when it is operated for, for instance, both of the private use and business use, it has involved the problem that the convenience in using the stored data becomes lower.

### BRIEF SUMMARY OF THE INVENTION

The present invention is intended to solve the foregoing problem, and an object of the invention is to provide a mobile radio terminal device which is high in convenience in using stored data, for instance, when the terminal device is used for both private use and business use.

In the present invention, to establish the above-noted object, the mobile radio terminal device which performs a radio communication with a base station comprises an operation unit configured to receive a operation from a user; a display unit configured to display at least character information; a first control unit configured to set at least either a first operation mode or a second operation mode in response to the operation through the operation unit; a storage unit configured to store a plurality of data sets in which names, first identification information, second identification information, an operation mode associated with the first identification information, and an operation mode associated with the second identification information are associated with one another; detecting unit configured to detect the data set, including identification information with the same operation mode as that set by the first control unit associated therewith, from the storage unit if the operation is made through the operation unit; and a second control unit configured to make a list of names included in the data set detected from the detecting unit to display it on the display unit.

As mentioned above, in the present invention, the mobile radio terminal device stores the plurality of the data sets in which the names, first identification information, second identification information, operation mode associated with the first identification information, and operation mode associated with the second identification information are associated with one another, and when the request is made through the input device, makes a list of the names of the data sets including the identification information in which the same operation mode as that set by the first control unit is associated to display it on the display means.

Accordingly, since the present invention can display the names of the data sets corresponding to the operation modes, the mobile radio terminal device which is high in convenience in using the stored data can be provided, for instance, when being operated for both private use and business use.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an exemplary circuit block diagram illustrating a configuration of an embodiment of a mobile radio terminal device regarding the present invention;

FIG. 2 is an exemplary flowchart for explaining an operation regarding a first embodiment of the mobile radio terminal device illustrated in FIG. 1;

FIG. 3 is another exemplary flowchart for explaining an operation regarding the first embodiment of the mobile radio terminal device illustrated in FIG. 1;

FIG. 4 is an exemplary view illustrating an example of a display indicated on a display unit by the operation regarding the first embodiment of the terminal device illustrated in FIG. 1;

FIG. 5 is an exemplary flowchart for explaining an operation regarding a second embodiment of the terminal device illustrated in FIG. 1;

FIG. 6 is another exemplary flowchart for explaining an operation regarding the second embodiment of the terminal device illustrated in FIG. 1;

FIG. 7A is an exemplary view illustrating an example of a display indicated on a display unit by the operation regarding the second embodiment of the terminal device illustrated in FIG. 1;

FIG. 7B is another exemplary view illustrating an example of a display indicated on the display unit by the operation regarding the second embodiment of the terminal device illustrated in FIG. 1;

FIG. 7C is another exemplary view illustrating an example of a display indicated on the display unit by the operation regarding the second embodiment of the terminal device illustrated in FIG. 1;

FIG. 7D is another exemplary view illustrating an example of a display indicated on the display unit by the operation regarding the second embodiment of the terminal device illustrated in FIG. 1;

FIG. 7E is another exemplary view illustrating an example of a display indicated on the display unit by the operation regarding the second embodiment of the terminal device illustrated in FIG. 1;

FIG. 8 is an exemplary flowchart for explaining a modified example of the operation regarding the second embodiment of the terminal device illustrated in FIG. 1;

FIG. 9 is an exemplary flowchart for explaining an operation regarding a third embodiment of the terminal device illustrated in FIG. 1;

FIG. 10 is another exemplary flowchart for explaining an operation regarding the third embodiment of the terminal device illustrated in FIG. 1;

FIG. 11 is another exemplary flowchart for explaining an operation regarding the third embodiment of the terminal device illustrated in FIG. 1;

FIG. 12A is an exemplary view illustrating an example of a display indicated on the display unit by the operation regarding the third embodiment of the terminal device illustrated in FIG. 1;

FIG. 12B is another exemplary view illustrating an example of a display indicated on the display unit by the operation regarding the third embodiment of the terminal device illustrated in FIG. 1;

FIG. 12C is another exemplary view illustrating an example of a display indicated on the display unit by the operation regarding the third embodiment of the terminal device illustrated in FIG. 1;

FIG. 13 is an exemplary flowchart for explaining a modified example of the operation regarding the third embodiment of the terminal device illustrated in FIG. 1;

FIG. 14A is an exemplary view illustrating an example of a display indicated on the display unit by the modified example of the operation regarding the third embodiment of the terminal device illustrated in FIG. 1; and

FIG. 14B is another exemplary view illustrating an example of a display indicated on the display unit by the modified example of the operation regarding the third embodiment of the terminal device illustrated in FIG. 1.

### DETAILED DESCRIPTION OF THE INVENTION

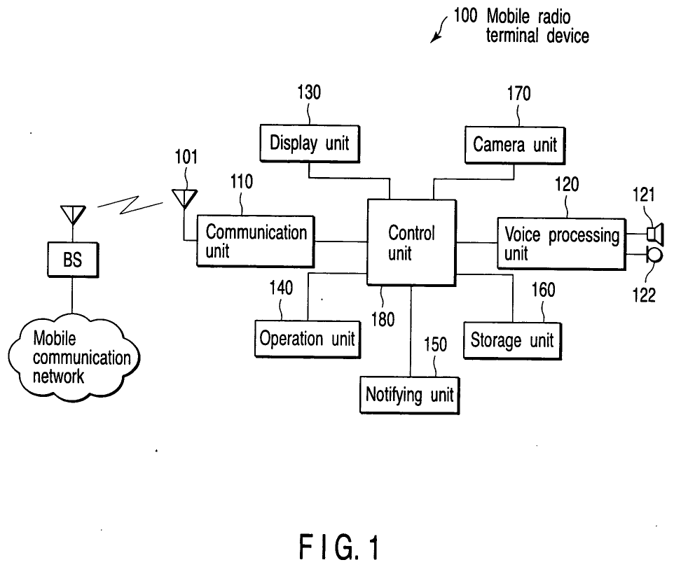

Hereinafter, an embodiment of the present invention will be set forth with reference to the drawings. FIG. 1 shows a configuration of a mobile radio terminal device regarding the embodiment of the present invention. In the following explanation, the terminal device will be described by taking a cellular phone set 100 as an example of the terminal device. The cellular phone set 100 connects itself by radio to a public base station BS contained in a mobile communication network to communicate therewith.

The cellular phone set 100 is provided with an antenna 101, a communication unit 110, a voice processing unit 120, a display unit 130, an operation unit 140, a notifying unit 150, a storage unit 160, a camera unit 170, and a control unit 180.

The antenna 101 receives a radio signal transmitted from the base station BS and transmits a radio signal to the base station BS from the cellular phone set 100.

The communication unit 110 makes a radio communication with the base station BS via the antenna 101. More specifically, the communication unit 110 down-converts the radio signal received by the antenna 101 to demodulate it and obtains coded voice data and e-mail data transmitted from a communication opposite station. Further, the communication unit 110 modulates a baseband signal by using the coded voice data and e-mail data obtained from the voice processing unit 120 through the control unit 180, up-converts it to generate a radio signal, and transmits it to the base station BS through the antenna 101.

The voice processing unit 120 decodes the coded voice data demodulated by the communication unit 110 to reproduce a voice signal, and amplifies and outputs by and from a built-in loud speaker 121. Thereby, a voice transmitted from the communication opposite station is transmitted to a user. The voice processing unit 120 encodes the voice signal input through a built-in microphone 122 to generate the coded voice data and supplies it to the communication unit 110 through the control unit 180.

The display unit 130 is a display unit using a liquid crystal display (LCD), etc., and video-displays a variety of pieces of visual information such as a text and an image by means of the control through the control unit 180.

The operation unit 140 has a plurality of key switches, etc., to receive a request from a user. The notifying unit 150 notifies an occurrence of an incoming call to the user by a sound or vibration and the control by the control unit 180 enables selectively performing any one or both of notification by sound and vibration.

The storage unit 160 stores address book data in which control program and control data of the control unit 180, telephone numbers, names, and image data of face photographs, etc., are associated with one another, and also stores image data of still images, moving images, etc., transmitted/received e-mail data, and parameters of mail display functions and the like.

The storage unit 160 stores subject setting information showing setting of a subject (operation mode). As for one example of the subject, “private” and “business” will be taken in the following descriptions. The storage unit 160 stores wallpaper images and menu display images used when the subject is set to “private”, and wallpaper images and menu display images used when the subject is set to “business”, respectively. The wallpaper images include images to be displayed on the display unit 130 during incoming call waiting time. The menu display includes displays for presenting options to the user or receiving the request from the user.

The camera unit 170 is a digital camera using an imaging element such as a charge-coupled device (CCD) and a complementary metal oxide semiconductor (CMOS), and images the still images and moving images in accordance with the instruction from the control unit 180 to output image data obtained by means of this imaging.

The control unit 180 integrally conducts each unit of the corresponding cellular phone set 100. The control unit 180 includes, for instance, functions, as control functions of a voice communication, of an incoming call control function to receive an incoming call signal, of an originating call control function to originate a call when the request form the user is received, and of a communication control function to establish a communication link with a communication partner in controlling the originating/incoming and perform transmission/reception of voice data and input/output of voices.

The control unit 180 further controls the corresponding mobile radio terminal device in response to the set subject (operation mode). Namely, when entering an input to set the subject from the user through the operation unit 140, the control unit 180 stores identification information of the input subject (for instance, “private” or “business”) in a storage unit 160, as subject setting information. The control unit 180 then reads out wallpaper image data corresponding to the set subject to display it as an incoming call waiting image onto the display unit 130 and also reads in image data of design corresponding to the setting from the storage unit 160 to conduct a menu display.

The control unit 180 has a function of displaying a list of only the data corresponding to the set subject, or preferentially displaying the data corresponding to the set subject in the higher order of the list when it displays, in a list, the address book data and a variety of items of data in response to the request from the user through the operation unit 140.

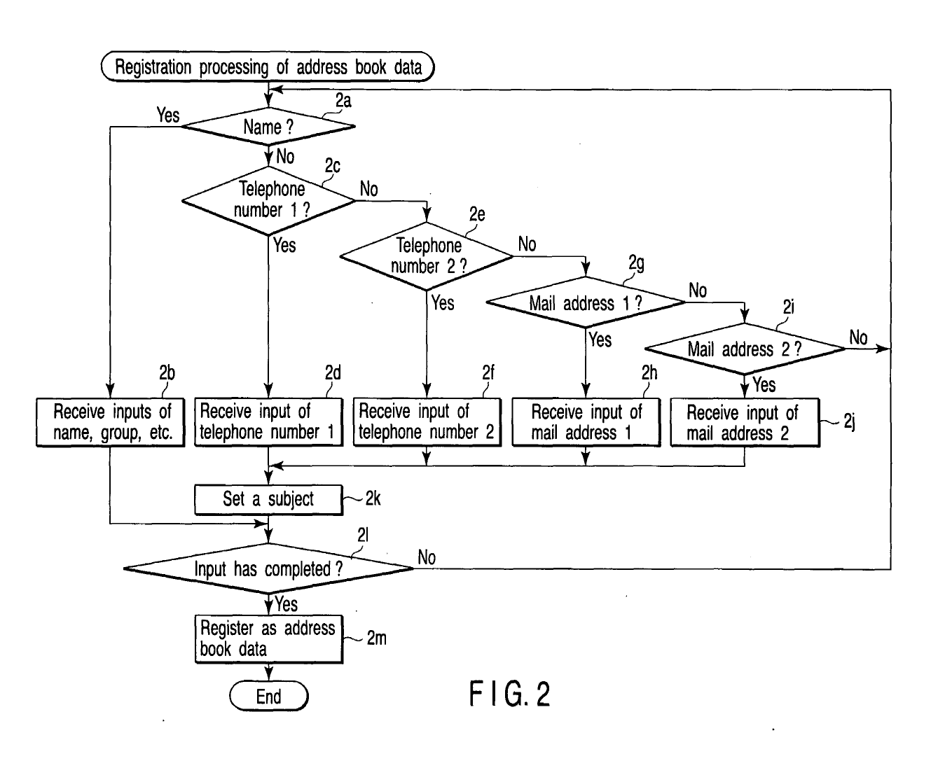

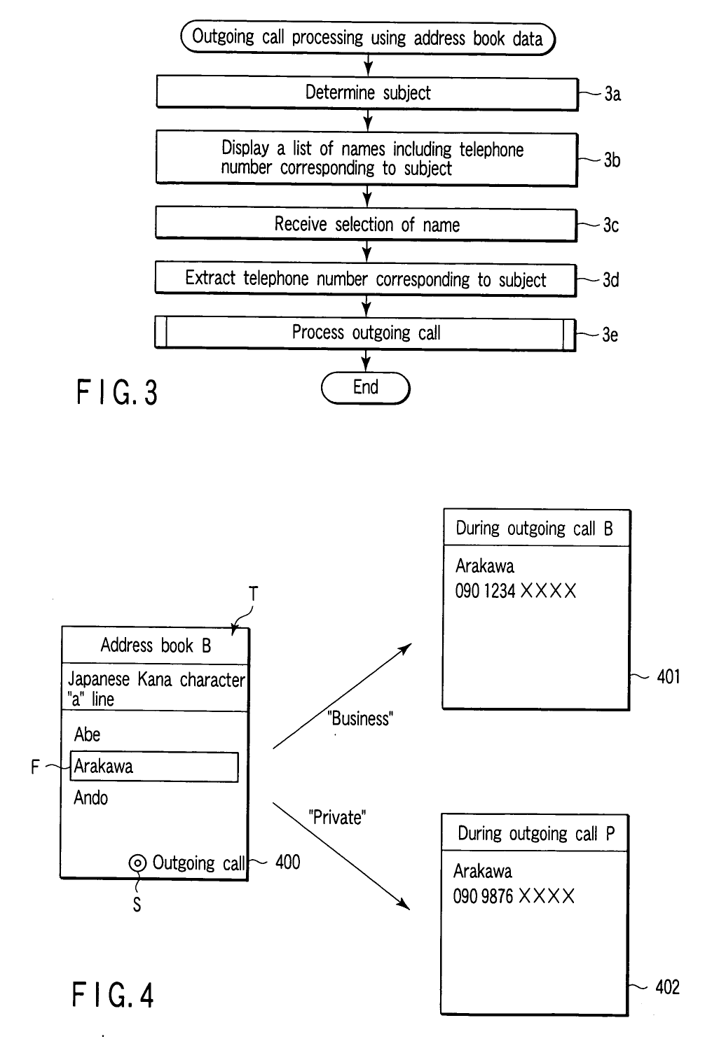

Next to this, operations of the mobile radio terminal device regarding the first embodiment of the invention will be set forth. FIG. 2 shows a processing to register the address book data and FIG. 3 shows a processing to make an originating call by using the address book data. The flowcharts depicted in those figures are based on the control program stored in the storage unit 160 to be executed by means of the control unit 180.

The processing of the registration of the address book data will be mentioned with reference to FIG. 2. When detecting that the user conducts a prescribed operation to request the registration of the address book data, the control unit 180 starts up the relevant processing.

At first, in a step 2a, the control unit 180 determines whether the input of the name is performed or not on the basis of the operation to the operation unit 140 by the user. Here, if it is determined that the name has been input, the control unit 180 shifts to a step 2b. On the contrary, if it is determined that the name has not been input, it shifts to a step 2c.

In the step 2b, the control unit 180 receives the input of the information of names to be registered in the address book, the group with the names belonging thereto, the reading of a Chinese character by writing Kana at its side, and the like through the operation unit 140 to shift to a step 21. Namely, the control unit 180 receives inputs, for instance, of text data of “Taro Yamada” as a name, identification information showing “friend” as a group, and text data of “Taro Yamada” as the reading of a Chinese character by writing Kana at its side.

In the step 2c, the control unit 180 determines whether or not the input of “telephone number 1” is performed, based on the operation of the operation unit 140 by the user. Here, if it is determined that the input of the “telephone number 1” is performed, the control unit 180 moves to a step 2d. On the contrary, if it is determined that the input of the “telephone number 1” is not performed, the flowchart moves to a step 2e.

In the step 2d, the control unit 180 receives the input of the “telephone number 1” then makes a shift to a step 2k. That is, the control unit 180 receives the input of, for example, a telephone number for private “03xxxxxxxx” of “Taro Yamada” as the “telephone number 2”.

In the step 2e, the control unit 180 determines whether “telephone number 2” is input on the basis of the operation to the operation unit 140 by the user. Here, having determined that the “telephone number 2” is input, the control unit 180 shifts to a step 2f. On the contrary, having determined that the “telephone number 2” is not input, the control unit 180 shifts to a step 2g.

In the step 2f, the control unit 180 receives the input of the “telephone number 2” then moves to the step 2k. That is, the control unit 180 receives, for instance, a telephone number for business of “Taro Yamada” “090xxxxxxxx” as the “telephone number 2”.

In the step 2g, the control unit 180 determines whether or not an input of “mail address 1” has been performed on the basis of the operation to the operation by the user. Here, in the event in which the “mail address 1” has been input, the control unit 180 shifts to a step 2h. On the contrary, in the event in which “mail address 1” has not been input, the control unit 180 shifts to the step 2i.

In the step 2h, the control unit 180 receives the input of the “mail address 1” to transfer to the step 2k. Namely, the control unit 180 receives an input, for example, yamada@xxx.yy.jp for private of “Taro Yamada”, as the “mail address 1”.

In the step 2i, the control 180 determines whether an input of “mail address 2” is conducted or not on the basis of the operation to the operation unit 140 by the user. Here, if it is determined that the input of the “mail address 2” is conducted, the control unit 180 transfers to a step 2j. On the contrary, if it is determined that the input of the “mail address 2” is not conducted, the control unit 180 moves to the step 2a to continue the receptions of the “mail address 2”.

In the step 2j, the control unit 180 receives the input of the “mail address 2” to shift to the step 2k. Namely, the control unit 180 receives the input, for instance, yamada@zzz.co.jp for business of “Taro Yamada”.

In the step 2k, the control 180 receives designation of subjects to be associated with information input in the steps 2d, 2f, 2h and 2j, respectively, and associates the identification information of the received subjects with the information input in the steps 2d, 2f, 2h and 2j, respectively, then, shifts to the step 2k.

For instance, it is presumed that, in the steps 2d and 2h, the data of “private” has been received; the control unit 180 receives the designation of “private” as the subject from the user for the received data. Thereby, the control unit 180 associates the identification information showing the “private” as the subject with the received data.

In a similar way, for instance, in the steps 2f and 2j, it is supposed that the data of the “business” has been received; the control unit 180 receives the designation of the “business” as the subject from the user for the data of the “business”. Thereby, the control unit 180 associates the identification information showing the “business” as the subject with the data of the “business”.

In the step 21, the control unit 180 determines whether or not an instruction to end the input from the user thorough the operation unit 140. Here, if it is determined that the instruction to end the input has been received, the control unit 180 shifts to a step 2m. On the contrary, if it is determined that the instruction to end the input has not been received, the controller 180 shifts to the step 2a to continue receiving the data inputs.

In the step 2m, the control unit 180 stores the data which has been input in the steps 2b, 2d, 2f, 2h and 2j, respectively, and the identification data of the subject which has been input so as to be associated with the above-mentioned data in the step 2k, as one item of address book data (one data set) in the storage unit 160 and ends this processing. Accordingly, one piece of the address book data results in the registration in the storage unit 160.

Next, referring to FIG. 3, operations of a transmission using the address book data will be set forth. When the control unit 180 detects that the user has performed a prescribed operation to request a transmission using the address book data to the operation unit 140, it starts up the corresponding processing.

Firstly, in a step 3a, the control unit 180 refers to subject setting information stored in the storage unit 160 to determine what the set subject is, and shifts to a step 3b. That is, the control unit 180 determines if the set subject is “private” or “business”.

In the step 3b, the control unit 180 extracts the address book data including the data of the telephone number corresponding to the set subject out of the address book data stored in the storage unit 160 on the basis of the determination result from the step 3a and makes a list of the names included in the address book data to display the list on the display unit 130, and then shifts to the step 3c. An example of this aspect will be depicted in FIG. 4. A display 400 shows a display example of the display unit 130 in that case.

In the step 3c, the control unit 180 receives a selection of a name from the user through the operation unit 140 to move to a step 3d. As for a specific example of a selecting operation, as shown in the display 400 in FIG. 4, it is determined that the name of “Arakawa” being in focus F at that time has been selected to receive “Arakawa”, by moving the focus F in response to the operation to the operation unit 140 by the user, and after this, when the user presses down a key corresponding to an outgoing call S.

In the step 3d, the control unit 180 refers to the address book data of the name received in the step 3c, extracts the telephone number corresponding to the subject which has been set to move to a step 3e. At this moment, for example, in the case in which the “business” is set as the subject, in a state where the address book data of the name “Arakawa” includes the telephone number 1 corresponding to the subject “private” and the telephone number 2 corresponding to the subject “business”, and if the “business” is set as the subject, the control unit 180 results in the telephone number 2 being extracted.

In the step 3e, the control unit 180 controls the communication unit 110 to make an originating call to the telephone number extracted through the step 3d, and ends this processing. Namely, in the event of setting of the “business” as the subject, the communication unit 110 makes an originating call by using the telephone number 2 corresponding to the subject “business” out of the address book data of the name “Arakawa” to perform a display indicated at a display 401 in FIG. 4 onto the display unit 130. On the contrary, when the “private” is set as the subject, the communication unit 110 makes an originating call by using the telephone number 1 corresponding to the subject “private” out of the address book data of the name “Arakawa” to perform a display indicated at a display 402 in FIG. 4 onto the display unit 130.

As described above, the mobile radio terminal device with the afore-mentioned configuration extracts the address book data including the telephone numbers associated with the preset subject to display the names in a list. The terminal device then receives the designation of outgoing call destinations from the list to make an outgoing call by using the telephone number corresponding to the set subject out of the telephone numbers associated with the designated names.

Therefore, in operating, for instance, for both private use and business use, the terminal device with the afore-mentioned configuration can easily originate a call by designating the telephone number corresponding to the set subject, so that it is high in convenience.

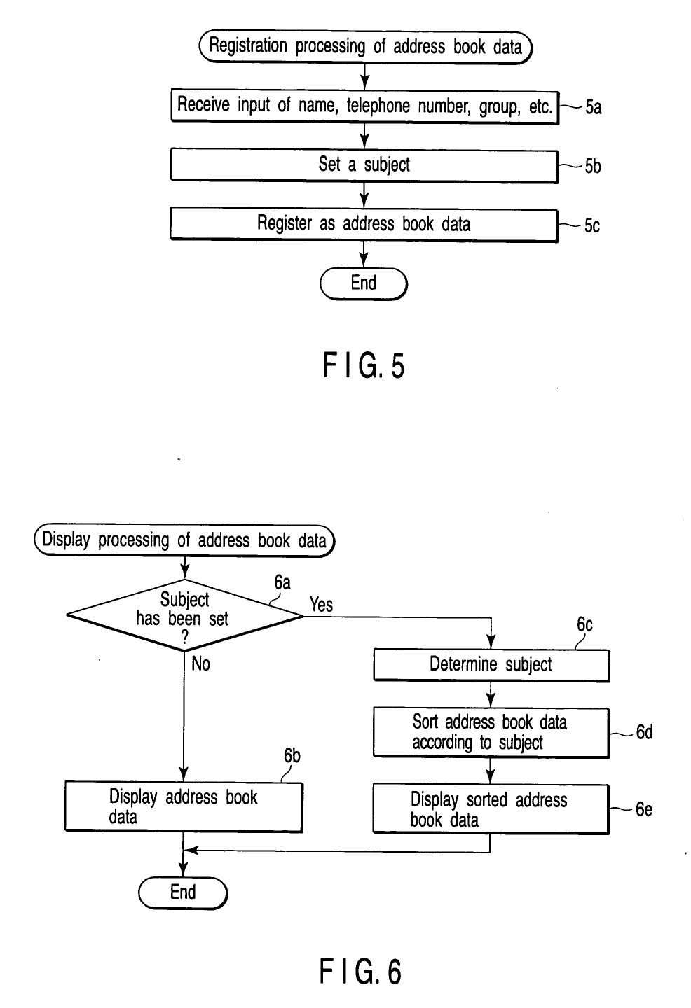

Next, operations of a mobile radio terminal device regarding a second embodiment will be described. FIG. 5 illustrates a processing of registering the address book data, and FIG. 6 illustrates a display processing of the address book data. These flowcharts illustrated in the FIGS. 5 and 6 are based on the control program stored in the storage unit 160 and executed through the control unit 180.

The processing to register the address book data will be explained with reference to FIG. 5. When detecting that the user conducts a prescribed operation to require the registration of the address book data to the operation unit 140, the control unit 180 starts up the relevant processing.

At first, in a step 5a, the control unit 180 receives inputs of the names, reading of the Chinese character by writing Kana at its side, telephone numbers, mail addresses, groups, etc., to shift to the step 5b.

In the step 5b, the control unit 180 receives the designation of the subject to be associated with the names input in the step 5a to associate the received identification information of the subjects with the names input in the step 5a and shifts to a step 5c. For instance, it is supposed that the control unit 180 receives the names regarding “private” in the step 5a, and then, in the step 5b, the user designates the “private” as the subject. Thereby, the control unit 180 associates the identification information showing the “private” as the subject with the forgoing names.

In a step 5c, the control unit 180 stores the data, which is input in the step 5a and the identification data of the subject which is input in the step 5b so as to associate with such data input in the step 5a, in the storage unit 160, as one piece of the address book data to end the corresponding processing. Consequently, one piece of the address book data is registered in the storage unit 160.

In the flowchart in FIG. 6, having described that each one telephone number and mail address are input, respectively, a plurality of telephone numbers and mail addresses may be input as shown in FIG. 2. However, even if a plurality of the telephone numbers and mail addresses are input, only one subject is set for one item of address book data so as to associate the subject with the names.

Next to this, a processing to display the address book data will be explained with reference to FIG. 6. When detecting that the user conducts a prescribed operation to request a display of the address book data to the operation unit 140, the control unit 180 starts the processing.

In a step 6a, the control unit 180 firstly refers to the subject setting information stored in the storage unit 160 to determine whether a subject has already been set or not. Here, if any subject has been set, the processing shifts to a step 6c, and on the contrary, otherwise it shifts to a step 6b.

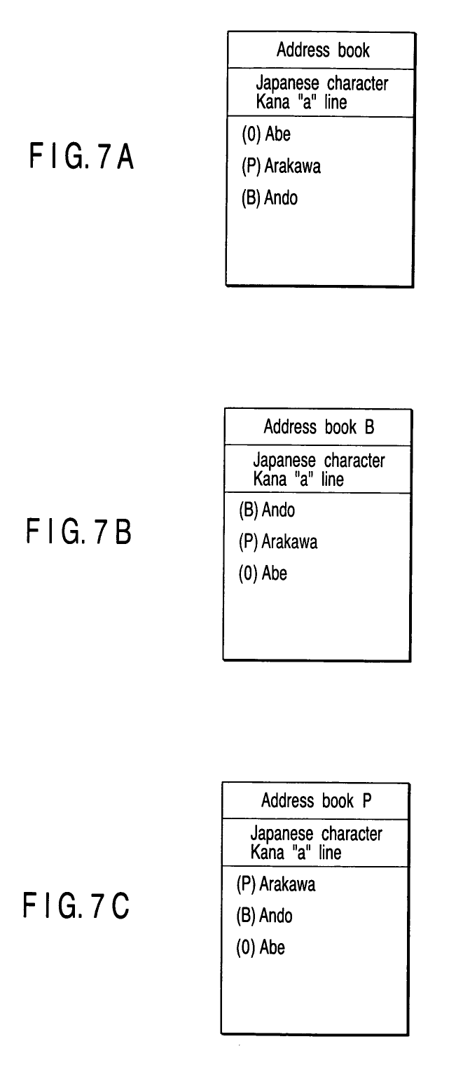

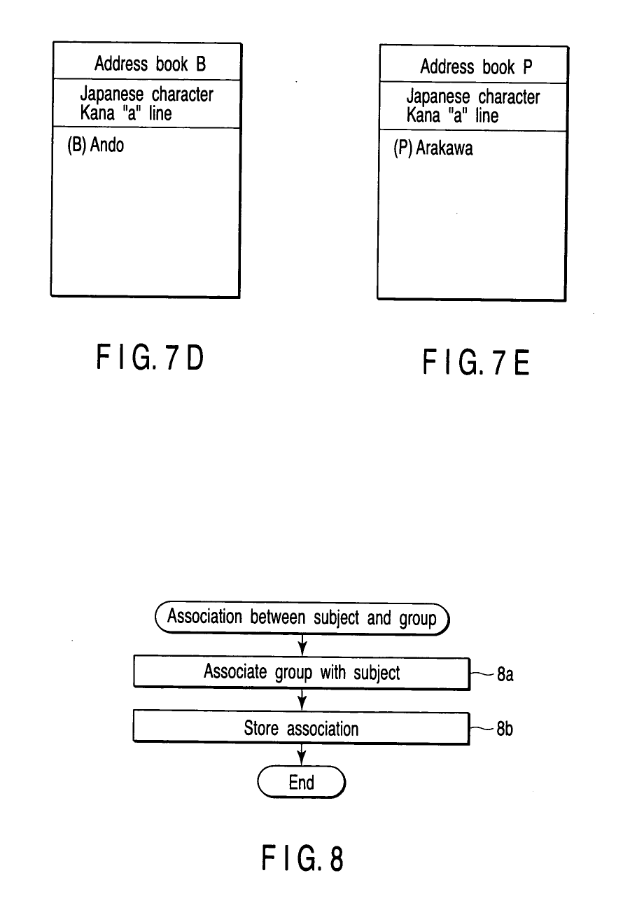

In the step 6b, the control unit 180 reads out the address book data from the storage unit 160 to make the address book data as a list based on the order of the reading of a Chinese character by writing Kana at its side (for example, order of Japanese syllabic character Kana), and displays it on the display unit 130. FIG. 7A shows an expression example of the display unit 130 in the step 6b. Here, the subject not having been set, an address book data of Japanese syllabic character kana “a” line is displayed in accordance with the order of the reading of a Chinese character by writing Kana at its side.

When receiving the instruction from the user through the operation unit 140, the control unit 180 displays the details of the address book data (telephone number, group, etc.), and in a similar way, it displays, in a list, the address book data in other subjects in accordance with the received instruction. In such a state where the address book data is displayed in a list, if the user instructs to select any address book data through the operation unit 140, the control unit 180 receives the instruction to make outgoing calls by using the telephone numbers in the selected address book data based on the instruction.

On the other hand, in the step 6c, the control unit 180 refers to the subject setting information stored in the storage unit 160 to determine what the set subject is, and shifts to a step 6d. Namely, the control unit 180 determines whether the set subject is “private” or “business”.

In the step 6d, the control unit 180 reads out the address book data to create a list in which the address book data corresponding to the subject has been determined in the step 6c is classified (sorted) so as to be displayed on a priority basis, and shifts to a step 6e. The term “on a priority basis” means to set the data at high-order positions on the list.

In the step 6e, the control unit 180 displays the list created in the step 6d onto the display unit 130. Each example of aspects of such displays is illustrated in FIG. 7B and FIG. 7C, respectively. FIG. 7B shows an example of the case in which “business” is set as the subject, and displays the address book data with “business” associated therewith at the higher-order on the list. Similarly, FIG. 7C shows an example of the case in which “private” is set as the subject, and displays the address book data with “private” associated therewith at the higher-order on the list. As for the address book data having the same subject with one another, the priority order is decided in the order of the reading of a Chinese character by writing Kana at its side.

When accepting the instruction from the user through the operation unit 140, the control unit 180 displays the details of the address book data (telephone number, group, etc.), and similarly displays, in a list, the address book data of other subjects, in accordance with the instruction. In such a state where the address book data is displayed in a list like this, the instructing to select any address book data through the operation unit 140 by the user makes the control unit 180 receive the instruction to originate outgoing calls using the telephone numbers in the selected address book data in accordance with the instruction.

As mentioned above, in the case of displaying the address book data in a list, the mobile radio terminal device with the afore-mentioned configuration preferentially displays the address book data of the names associated with the preset subject to make outgoing calls in response to the request from the user.

Accordingly, for instance, when an operation for both the private use and business use is implemented, the mobile radio terminal device having the forgoing configuration displays the telephone numbers corresponding to the set subject on a preferential basis, so that it is high in convenience.

Further, in the flowchart depicted in FIG. 6, as shown in FIG. 7B and FIG. 7C, the address book data corresponding to the set subject having been displayed preferentially, only the address book data corresponding to the set subject may be displayed as shown in FIG. 7D and FIG. 7E. FIG. 7D shows an example of the case in which “business” is set as the subject. And FIG. 7E shows an example of the case in which “private” is set as the subject.

It has been described that the subject is set to the name in the flowchart depicted in FIG. 5, and that the subject may be set to the group. That is, a group including “family”, “relation”, “friend” and the like is set as the subject “private”, and a group including “company”, “business partner”, and the like is set as the subject “business”.

FIG. 8 illustrates a flowchart for describing a processing to associate a subject with a group. In a step 8a, the control unit 180 associates between the subject and the group to shift to a step 8b. In the step 8b, the control unit 180 stores subject-group associating information showing the association has been performed in the step 8a in the storage unit 160.

In this way, after the subject-group associating information is created, when a request for displaying the address book data is made through the operation unit 140, the control unit 180 preferentially displays the address book data belonging to the group corresponding to the set subject, or displays only the address book data belonging to the group corresponding to the set subject. Like this, even if the processing depending on the group is performed, the telephone number depends on the set subject being displayed preferentially, and the mobile radio terminal device becomes excellent in convenience.

In the foregoing embodiment, having described the address book data by taking it as data to be associated with a subject, the data may be data in another form, such as image data and music data. Hereinafter, the case in which the subject is associated with data another than the address book data will be set forth as a third embodiment.

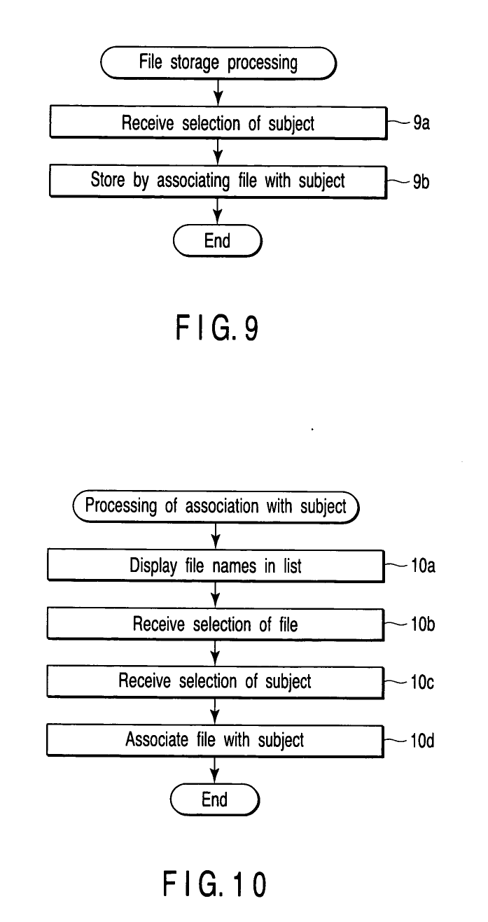

FIG. 9 illustrates a processing to store image data imaged by the camera unit 170, and FIG. 10 illustrates a processing to associate the stored image data with a subject. The flowcharts illustrated in the FIGS. 9 and 10 are based on the control program stored in the storage unit 160 and executed by means of the control unit 180.

Referring now to FIG. 9, the processing to store the image data imaged by the camera unit 170 will be described. When the camera unit 170 picks up an image, the control unit 180 starts up the processing so as to store the image data obtained through the picking up of the image.

At first, in the step 9a, the control unit 180 receives the designation of the subject to be associated with the image data obtained by imaging from the user through the operation unit 140, and associates the identification information of the received subject to move to the step 9b. For instance, in the case of private imaging, in the step 9a, the user designates “private” as the subject. Thereby, the control unit 180 associates the image data with the identification information showing “private” as the subject.

In the step 9b, the control unit 180 associates the aforementioned image data with the identification data of the subject input in the step 9a to store it in the storage unit 160, then, ends the concerned processing. As mentioned above, the identification data of the subject is added to the image data picked up by the camera unit 170 and it is stored as one data set in the storage unit 160.

Next, referring to FIG. 10, a processing to associate the stored image data with the subject will be explained. When the user requests the setting of the subject to the image data through the operation unit 140, the control unit 180 starts the relevant processing.

In a step 10a, the control unit 180 firstly makes a list of file names of the image data stored in the storage unit 160 to display it on the display unit 130 then moves to the step 10b.

In the step 10b, the control unit 180 selects any one of file names displayed as a list on the display unit 130 in accordance with an instruction from the user through the operation unit 140 to shift to a step 10c.

In the step 10c, the control unit 180 receives designation of the subject to be associated with the image data selected in the step 10b from the user through the operation unit 140, associates the received identification information of the subject with the image data of the file names selected in the step 10b then shifts to a step 10d. For example, when intending to set the image data as a private one, in the step 10c, the user designates “private” as the subject. Thereby, the control unit 180 associates the identification information showing “private” as the subject with the forgoing image data.

In the step 10d, the control unit 180 associates the identification data of the subject input in the step 10c with the image data to store it as one data set in the storage unit 160, then ends the relevant processing. Such a processing results in adding the identification data of the subject to the image data stored in the storage unit 160 and storing it in the storage unit 160.

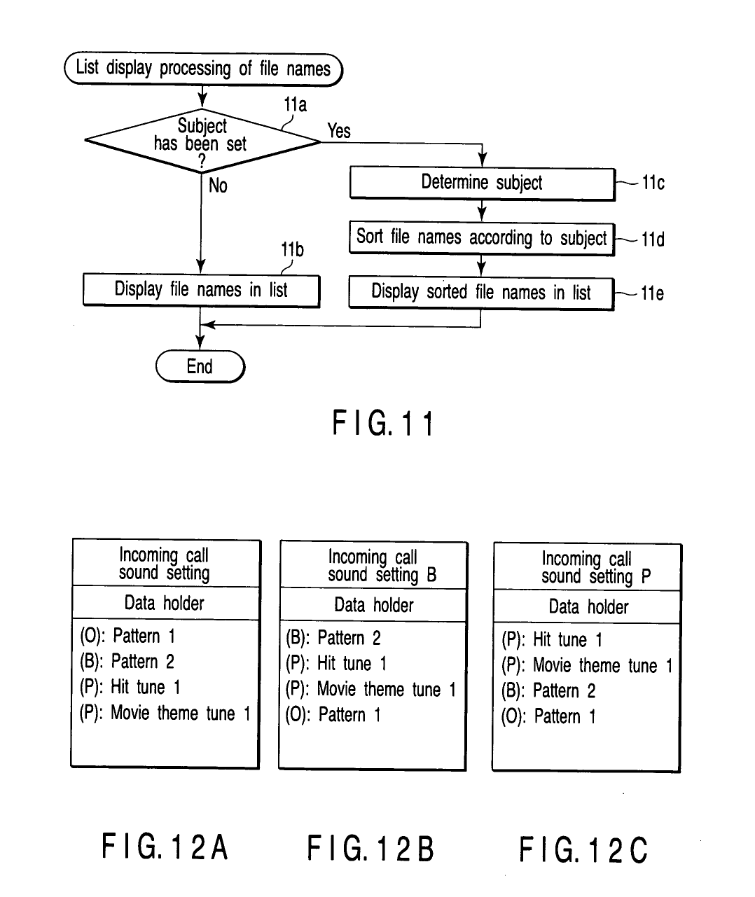

Next to this, referring now to FIG. 11, a processing to display a list of the music data stored in the storage unit 160 will be described. Here, although music data is taken as an example of display in a list, the foregoing image data may also be used. As for an example to display the music data in a list, the case of setting an incoming call sound is taken. It is presumed that the identification information identifying the subject is added beforehand to the music data by a processing similar to that illustrated in FIG. 9 and FIG. 10. When detecting that the user has conducted a prescribed operation to require setting the incoming call sound to the operation unit 140, the control unit 180 starts up the corresponding processing.

At first, in a step 11a, the control unit 180 refers to the subject setting information stored in the storage unit 160 to determine whether the subject has been set or not. Here, if any subject has been set, the control unit 180 moves to a step 11c, and if otherwise, the control unit 180 shifts to a step 11b.

In the step 11b, the control unit 180 reads out the file names of the music data from the storage unit 160, makes a list of the file names in accordance with alphabetical order and Japanese Kana syllabary order, and displays it on the display unit 130. FIG. 12A shows a display example of the display unit 130 in the step 11b. Here, not having been set the subject, the file names are displayed in accordance with the order of the file names.

Then, based on the instruction of the user through the operation unit 140, the control unit 180 displays the details of each music data and reproduces the music on the basis of the music data so that it can be heard. When selecting the file name by means of the instruction from the user through the operation unit 140, the control unit 180 sets the music data having the selected file name so as to use it as the incoming call sound then terminates the related processing.

On the other hand, in a step 11c, the control unit 180 refers to the subject setting information stored in the storage unit 160 to determine what the set subject is, then moves to a step 11d. Namely, the control unit 180 determines that the set subject is “private” or “business”.

In the step 11d, the control unit 180 reads out the address book data from the storage unit 160, creates a list classified (sorted) so as to preferentially display the music data corresponding to the subject determined in the step 11c, on the basis of the read out address book data, and shifts to a step 11e, wherein, “preferentially” means to set the music data at higher-order position in the list.

In the step 11e, the control unit 180 displays the list created in the step 11d onto the display unit 130. Examples of such an aspect will be depicted in FIG. 12B and FIG. 12C. FIG. 12B illustrates an example of the case in which “business” is set as the subject, and the music data with “business” associated therewith is displayed at the higher-order positions on the list. In a similar manner, FIG. 12C illustrates an example in the case in which “private” is set as the subject, and the music data with “private” associated therewith is displayed at the higher-order positions on the list. As for the music data having the same subject, its priority order is decided in the order depending on the file names.

The control unit 180 displays the details of the music data on the basis of the instruction from the user through the operation unit 140 to reproduce music, based on the music data to audition it. When the file name is selected by the instruction from the user through the operation unit 140, the control unit 180 sets the music data corresponding to the file name as the incoming call sound to end the related processing.

As described above, when displaying the image data and the music data other than the address book data in a list, the mobile radio terminal device, which is configured as mentioned above, displays the data associated with the preset subjects on a preferential basis.

Thus, according to the terminal device with the foregoing configuration, for instance, in the event of an operation for both the private use and business use, the terminal device becomes very convenient since the data corresponding to the set subject are preferentially displayed.

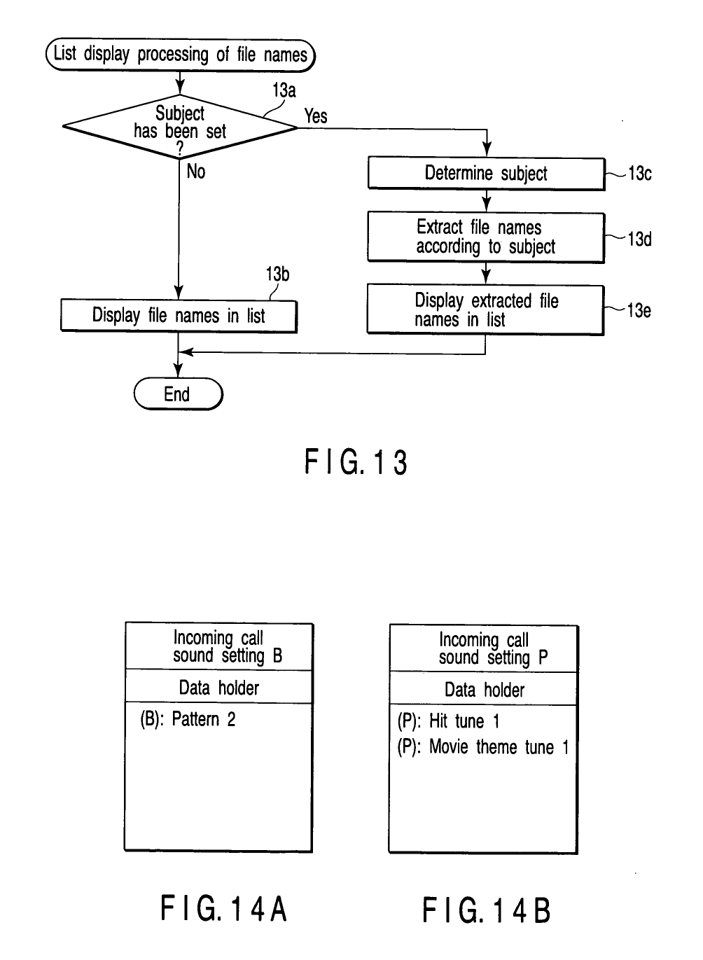

In the description with the use of FIG. 11, FIG. 12B and FIG. 12C, having explained about the case that the data corresponding to the set subject is displayed on a priority base, as a substitution for this, for instance, only the data corresponding to the set subject may be displayed. In this case, in substitution for the flowchart shown in FIG. 11, a processing in the flowchart shown in FIG. 13 is implemented.

In a step 13a, the control unit 180 firstly refers to the subject setting information stored in the storage unit 160 to determine whether or not the subject has been set. Here, if any subject has been set, the control unit 180 moves to a step 13c, in contrast, otherwise stated, it moves to a step 13b.

In the step 13b, the control unit 180 reads out the file names of the music data from the storage unit 160, creates a list of the file names which have been subjected to the alphabetical order and Japanese Kana character order, and displays it on the display unit 130. FIG. 12A illustrates a display example of the display unit 130 in the step 13b. Here, the subject not having been set, the music data is displayed in accordance with the order of the file names.

Then, based on the instruction from the user through the operation unit 140, the control unit 180 displays the details of each music data and reproduces music so as to be heard on the basis of the music data. When the file name is selected by the instruction from the user through the operation unit 140, the control unit 180 sets the music data corresponding to the selected file name to be used as the incoming call sound then ends the concerned processing.

On the other hand, in the step 13c, the control unit 180 refers to the subject setting information stored in the storage unit 160, determines what the set subject is, and makes a shift to a step 13d. Namely, the control unit 180 determines if the set subject is “private” or “business”.

In the step 13d, the control unit 180 reads out the address book data from the storage unit 160, makes a classified list so as to display only the music data corresponding to the subject which has been determined in the step 13c on the basis of the read out address book data and shifts to a step 13e.

In the step 13e, the control unit 180 displays the list made in the step 13d onto the display unit 130. Examples of these aspects are illustrated in FIG. 14A and FIG. 14B. FIG. 14A shows an example of the case that the subject “business” is set as a subject, and only the music data with the subject “business” associated therewith is displayed. Similarly, FIG. 14B shows an example in which the subject “private” is set, the only the music data with the subject “private” associated therewith is displayed. As for the music data having the same subject, its priority order is decided in order of file names.

The control unit 180 then displays the details of the music data in accordance with the instruction from the user through the operation unit 140 and reproduces music, based on the music data so as to audition. When the file name is selected by means of the instruction from the user through the operation unit 140, the control unit 180 sets the selected file name so as to be used as the incoming call sound, then ends this processing.

According to such a processing, when displaying the image data and music data other than the address book data in a list, the control unit 180 displays only the data associated with the preset subject. Therefore, for example, when the terminal device is operated both for private use and business use, it becomes convenient, since only the data corresponding to the set subject is displayed. In the third embodiment, having described a case of the data other than the address book data, it goes without saying that the third embodiment may be applied to the address book data.

Further, the present invention is not limited to the aforementioned embodiments as they are, in an implementation phase, and this invention may be embodied in various forms without departing from the inventive concept thereof. Various types of the inventions can be formed by appropriately combining a plurality of constituent elements disclosed in the foregoing embodiments. Some of the elements, for example, may be omitted from the whole of the constituent elements shown in the embodiments given above. Further, the constituent elements over different embodiments may be appropriately combined.

Furthermore, as an example of the aforementioned modified embodiment, for instance, the foregoing embodiment having described the address book data by taking the telephone numbers as an example, similar effects are obtained with mail addresses. In the case of the telephone numbers, as mentioned above, the mobile radio terminal device makes an outgoing call to the selected telephone number. In the case of mail addresses, it creates an e-mail addressed to the selected mail address and transmits the created e-mail.

Needless to say, various modifications may be made without departing from the spirit or scope of the inventive concept of the present invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A mobile radio terminal device which performs a radio communication with a base station connected to a communication network, comprising:
operation unit configured to receive a operation from a user;
display unit configured to display at least character information;
first control unit configured to set at least either a first operation mode or a second operation mode in response to the operation through the operation unit;
storage unit configured to store a plurality of data sets in which names, first identification information, second identification information, an operation mode correlated with the first identification information, and an operation mode correlated with the second identification information are associated with one another;
detecting unit configured to detect the data set, including identification information with the same operation mode as that set by the first control unit associated therewith, from the storage unit if the operation is made through the operation unit; and
second control unit configured to make a list of names included in the data sets detected from the detecting unit to display it on the display unit.

2. The mobile radio terminal device according to claim 1, further comprising communication unit configured to perform a communication by using identification information associated with the same operation mode as that set by the first control unit out of identification information included in a data set corresponding to the selected name if a operation, for selecting names made in a list by the second control unit and displayed on the display unit, is made through the operation unit.

3. A mobile radio terminal device which performs a radio communication with a base station connected to a communication network, comprising:
operation unit configured to receive a operation from a user;
display unit configured to display at least character information;
storage unit configured to store a plurality of data sets in which names and a plurality of pieces of identification information are associated with one another, and further storing at least one piece of the plurality of the identification information out of the plurality of the identification information by associating the one piece with an operation mode; and
display control unit configured to display a name corresponding to identification information associated with a designated operation mode if the operation mode is designated by the operation unit, and if a display instruction of a list of the names is designated thereafter by the operation unit.

4. A mobile radio terminal device which performs a radio communication with a base station connected to a communication network, comprising:
operation unit configured to receive a operation from a user;
display unit configured to display at least character information;
first control unit configured to set at least either a first operation mode or a second operation mode in response to the operation through the operation unit;
storage unit configured to store a plurality of data sets in which names, identification information and operation modes are associated with one another;
detecting unit configured to detect a data set including the same operation mode as that set by the first control unit from the storage unit if the operation is made through the operation unit; and
second control unit configured to make a list of names included in the data set detected by the detecting unit to display it on the display unit.

5. The mobile radio terminal device according to claim 4, wherein the second control unit is configured to make a list of names included in the data set stored in the storage unit so as to display it on the display unit and preferentially displaying a name included in the data set detected by the detecting unit out of names included in the data sets stored in the storage unit.

6. A mobile radio terminal device which performs a radio communication with a base station connected to a communication network, comprising:
operation unit configured to receive a operation from a user;
display unit configured to display at least character information;
first control unit configured to set at least either a first operation mode or a second operation mode in response to a request through the operation unit;
storage unit configured to store a plurality of data sets in which data files, names of the data files and operation modes are associated with one another;
detecting unit configured to detect a data set including the same operation mode as that set by the first control unit if the operation is made through the operation unit; and
second control unit configured to make a list of names included in the data set detected by the detecting unit so as to display it on the display unit.

7. The mobile radio terminal device according to claim 6, wherein the second control unit is configured to make a list of names included in the data set stored in the storage unit so as to display it on the display unit and preferentially displaying a name included in the data set detected by the detecting unit out of names included in the data sets stored in the storage unit.
